(19) United States
(12) Patent Application Publication
(10) Pub. No.: US 2019/0090559 A1
(43) Pub. Date: Mar. 28, 2019

(54) DISPOSABLE MITTEN

(71) Applicant: Gluv Australia Pty Ltd, Brighton East (AU)

(72) Inventors: Cameron Traum, Brighton East (AU); Benjamin Carson, Albert Park (AU)

(21) Appl. No.: 15/527,084

(22) PCT Filed: Nov. 19, 2015
(86) PCT No.: PCT/AU2015/050729

§ 371 Date: May 16, 2017

(30) Foreign Application Priority Data
Nov. 21, 2014 (AU) 2014904706
Feb. 13, 2015 (AU) 2015900477

(51) Int. Cl. A41D 19/00; A41D 19/01; A41D 27/08; B65D 83/08; G09F 23/00; A47F 13/08

(52) U.S. Cl. CPC A41D 19/0072; A41D 19/01; A41D 27/08; A41D 2400/70; G09F 23/00; A47F 13/08; A41D 2400/52; B65D 83/0894

(57) ABSTRACT

A disposable mitten (10) having a mitten body (12) formed from first and second (layers (14, 16). Each layer (14, 16) as an inner surface and an outer surface, and an information display portion provided on at least one of the first and second layers (14, 16). Information provided in the information display portion is visible to the wearer while the mitten (10) in being worn.

### INTRODUCTION

The present invention relates generally to a disposable mitten. The mitten has particular application in the context of protecting a wearer's hand from fluids such as fuels and oils commonly found at service (or petrol or gas) stations and so will be hereinafter described generally in this context. However, it is to be appreciated that the invention may have other applications where it is desired to provide protection of a wearer's hand, or provide hygienic or safe handling of items. For example, the mitten may be adapted for use in home maintenance, such as for painting, cleaning and other short term hand protection requirements.

### BACKGROUND OF INVENTION

Disposable gloves are widely used in many applications. They provide a cheap, effective and hygienic way of protecting a wearer's hand from items to be handled. One issue with disposable gloves is that they generally fit a relatively small range of hand sizes, and are noticeably ill-fitting when worn by an individual with a smaller or larger hand size than that specifically designed for.

Moreover, disposable gloves don't generally lend themselves to be adorned with much, if any, information visible while the glove is being worn. This is because the rear surfaces of gloves are discontinuous, as they are broken up into the various finger receiving portions of the glove.

Disposable mittens can, at least in part, address these shortcomings associated with disposable gloves. In this regard, a disposable mitten can often accommodate a wider range of wearer hand sizes, such that a single size of mitten can potentially be worn by individuals with a wider range of hand sizes than is possible with a glove.

To date, difficulty has been encountered in providing information on mittens (and gloves) in the context of service station use, because fuels and oils can act as solvents to the currently used inks, thereby potentially compromising any information printed on the mitten in the event that they come into contact with the fuel/oil. Even more problematic is that the fuels can also act as solvents to the actual mitten (or glove) material, thereby often rendering the glove ineffective when coming into contact with fuels and oils.

It would therefore be desirable to provide a disposable mitten that at least partially addresses the above referred to issues inherent in existing disposable glove and mitten designs.

### SUMMARY OF INVENTION

According to a broad aspect of the present invention there is provided a disposable mitten. The mitten has a mitten body formed from first and second layers, with each layer having an inner surface and an outer surface. An information display portion is provided on at least one of the first and second layers; such that information provided in the information display portion is visible to the wearer while the mitten in being worn.

The mitten has been specifically designed to provide a wearer protection from fuel and like fluids, such as when re-fuelling a vehicle at a petrol station. The mitten is designed to be at least temporarily impervious to fuels or oils that a customer or employee is likely to encounter at a service station, thereby at least substantially preventing fuel from splashing or spilling onto their hand(s). This can be a particular problem, especially for individuals with sensitive skin, given that diesel fuel, in particular, does not evaporate from skin and so can remain on and irritate the skin.

The mitten is designed to be disposable, although it is to be appreciated that it may be re-usable. Thus, after an initial use, the mitten may be stored in a vehicle glove box or compartment for later use when the vehicle next requires re-fuelling.

The mitten also provides hygiene benefits, in that germs and bacteria potentially found on commonly handled items such as service station fuel pump handles, tyre inflators and the like won't be transferred to the hand of someone wearing the mitten.

The mitten may also be used in other, non-service station applications, where it is desired to minimise any harmful effects resulting from handling a particular object; or where potential hygiene issues may be associated with handling an object.

In one preferred form, the information display portion is printed on the outer surface of at least one of the first and second layers. Embodiments have been envisaged wherein the information display surface is provided on the outer surface of only one of the first and second layers, as well embodiments wherein the information display portion is printed on the outer surface of both the first and second layers. Printing on both layers potentially maximises the space available to print on. Also, it is to be appreciated that the mitten is designed to be worn on either hand of a wearer, such that the first layer can be considered as the front layer of the mitten when worn on the left hand of a wearer; and can be considered the back or rear layer when worn on the right hand of a wearer. Therefore, printing on both layers means that the printed matter is visible on the back side of a wearer's hand while holding an object, regardless of which hand the mitten is being worn on. Nevertheless, it may be desirable in some circumstances to print on only one layer, such as when it is intended for the mitten to be used around relatively strong solvents. Such solvents may compromise any printed information on, for example, the layer corresponding to the palm side of a wearer's hand. In these circumstances it may be desirable to print only on the layer corresponding to the back of a wearer's hand.

In one embodiment, the information display portion is printed using an ink that is not adversely affected or compromised by contact with at least some vehicle fuels and oils typically sold at service stations. Thus, any information displayed on the mitten won't be compromised by inadvertently coming into contact with at least some fuels and oils, at least in the relatively short term life of a mitten, even if re-used several times. Other inks often used to print on plastics have been found by the applicant not to provide this advantage.

The information applied to the mitten may be in a variety of forms. For example, it may be in the form of instructions for using an associated article, it may be in the form of a safety warning, or it may be in the form of advertising. Indeed, it may be any combination of these (or other) forms. The provision of advertising on the mittens is considered by the applicant to be particularly desirable, and may assist in the uptake of the mittens in service stations and other points of use.

In one form, the construction of the mitten is such that the first layer of the mitten body is sealed to the second layer of the mitten body around the respective periphery thereof, so as to form a closed end and an open end, and further forming a thumb-receiving portion and a fingers receiving portion. Sealing may be by way of, for example, heat sealing or radio frequency sealing.

In one embodiment, the first and second layers of the mitten are manufactured from high-density polyethylene (HDPE) including an OXO biodegradable additive. Use of this material is desirable, because it is a readily available and cost effective material, and also because it is biodegradable. The mitten may be transparent or opaque. It may also be coloured or at least tinted with any desired colour. The mitten may also be at least substantially manufactured from another suitable polymer or plastic in other embodiments.

The applicant also envisages another embodiment, wherein the mitten is manufactured from corn starch.

Some embodiments of the mitten include a thumb receiving portion for receiving the wearer's thumb, and a single finger receiving portion for receiving the wearer's four fingers. However, a variation of the mitten includes a thumb receiving portion, and two finger receiving portions. A first finger receiving portion may be provided for receiving the wearer's index and middle fingers, and a second finger receiving portion may be provided for receiving the wearer's ring and small fingers. Alternatively, a first finger receiving portion may receive one or three of the wearer's fingers, with a second finger receiving portion provided for receiving the wearer's remaining finger(s).

Still further, the mitten may include a third finger receiving portion. If so, then each of the first, second and third finger receiving portions may be configured for receiving either one or two fingers.

In one embodiment, a detachable portion is attached to and extends from each of the first and second layers adjacent the open end of the mitten. (In other embodiments, a detachable portion is attached to and extends from only one of the first and second layers adjacent the open end of the mitten). The detachable portion is provided for releasably mounting the mitten within a dispenser, with the mitten designed such that the detachable portion remains attached to the dispenser on removal of the mitten. To facilitate removal of the mitten from the detachable portion, the detachable portion (or mitten) includes a line of weakness, such as a line of perforations.

Preferably, the detachable portion is releasably mountable within the dispenser, for later removal.

In one preferred form, the detachable portion is asymmetric in shape, and a receiving portion of the dispenser is keyed to the shape of the detachable portion. In such an arrangement, the detachable portion is releasably mountable within the receiving portion in a single orientation relative to the dispenser. An advantage of this keyed feature is that multiple mittens, when added to the dispenser, all have the same orientation. That said, at least one embodiment of the invention includes a detachable portion and associated dispenser receiving portion that isn't asymmetric in shape.

In one form, the detachable portion includes oppositely disposed first and second sides, with the line of weakness provided along the first side, and with each side extending between oppositely disposed first and second ends. A line of weakness may be provided on the detachable portion. Alternatively, it may be provided on the mitten, or it may be provided between the detachable and the mitten. The first end includes a first attachment notch and the second end includes a second attachment notch, with the first notch being at least one of a different shape, size and relative position along the first side compared to the shape, size and relative position along the second side of the second notch, thereby providing the asymmetric form of the detachable portion.

In one form, a plurality of mittens is provided in a stacked arrangement, with the detachable portion of each mitten connected together to provide a cell of connected mittens. This facilitates ease of handling of multiple mittens and ease of mounting multiple mittens within the dispenser.

Each cell of mittens may include any desired number of individual mittens, with the applicant considering it desirable to provide cells each containing approximately fifty mittens.

So far, the invention has been described primarily in the context of the inventive mitten, although it is to be appreciated that the invention also extends to the inventive dispenser for use with the mitten(s). In this regard, and according to another broad aspect of the invention, there is provided a dispenser for containing and dispensing a disposable mitten. The dispenser has a receiving portion having an asymmetric shape for receiving a detachable portion of the disposable mitten. The detachable portion also has an asymmetric shape. The receiving portion of the dispenser is keyed to the shape of the detachable portion, such that the detachable portion is releasably mountable within the receiving portion in a single orientation relative to the dispenser.

The dispenser is broadly described in the preceding paragraph in the context of use with a single mitten, although it is to be appreciated that the dispenser has been specifically designed for receiving and retaining a plurality of mittens in one or more cells of stacked mittens. Thus, the dispenser is considered to be particularly suitable for mounting, for example, adjacent a service station fuel pump where customers can, in turn, remove a single mitten or pair of mittens prior to re-fuelling their vehicles.

In yet another broad form of the invention there is provided a portable container for containing and individually dispensing a plurality of disposable mittens. In use, each of the plurality of mittens is individually folded and packaged in the portable container. The applicant has devised such an arrangement so as to provide a relatively small number of mittens for personal use, with the portable container of a size for conveniently storing in the cabin of a motor vehicle, in a clothing pocket, in a bag or handbag.

In one preferred form, the portable container is manufactured from cardboard, and contains approximately fifteen folded mittens. The portable container preferably also contains a tear-open flap for individually removing the folded mittens therefrom. The tear-open flap is preferably re-closable.

Other forms of portable container are also envisaged, including versions manufactured from plastic film containing, say, four mittens (although this number may be increased or decreased). A portable container manufactured from paper is also envisaged. Yet another packaging option includes bulk packaging a relatively large number of mittens.

Alternative forms of the portable container include the mittens being contained within the container in an interleaved arrangement or group folded together.

### BRIEF DESCRIPTION OF DRAWINGS

It will be convenient to hereinafter describe preferred embodiments of the invention with reference to the accompanying drawings. The particularity of the drawings is to be understood as not limiting the preceding broad description of the invention.

FIG. 1 is a plan view of a disposable mitten according to one embodiment of the present invention.

FIGS. 2a to 2c illustrate how the mitten shown in FIG. 1 may be utilised in a petrol station application.

FIG. 3 is a perspective front view of a dispenser according to another embodiment of the present invention configured for use with the disposable mitten shown in FIG. 1.

FIG. 4 is a front view of the dispenser shown in FIG. 3, but with a front cover portion shown in the open position.

FIG. 5 is a perspective front view of a portion of the mitten shown in FIG. 1 when releasably mounted within the dispenser shown in FIG. 3, and with the front cover portion of the dispenser in the open position.

FIG. 6 is a perspective view of a portable container according to another embodiment of the present invention, showing a tear-open flap in the open position, and further showing several folded disposable mittens contained therein.

FIG. 7 shows a front side of a disposable mitten according to yet another embodiment of the present invention, and of the type contained within the portable container shown in FIG. 6.

FIG. 8 shows the rear side of the disposable mitten of FIG. 7.

FIG. 9 shows the portable container of FIG. 6 in the form of a blank.

FIG. 10 is a plan view of a disposable mitten according to another embodiment of the present invention.

### DETAILED DESCRIPTION

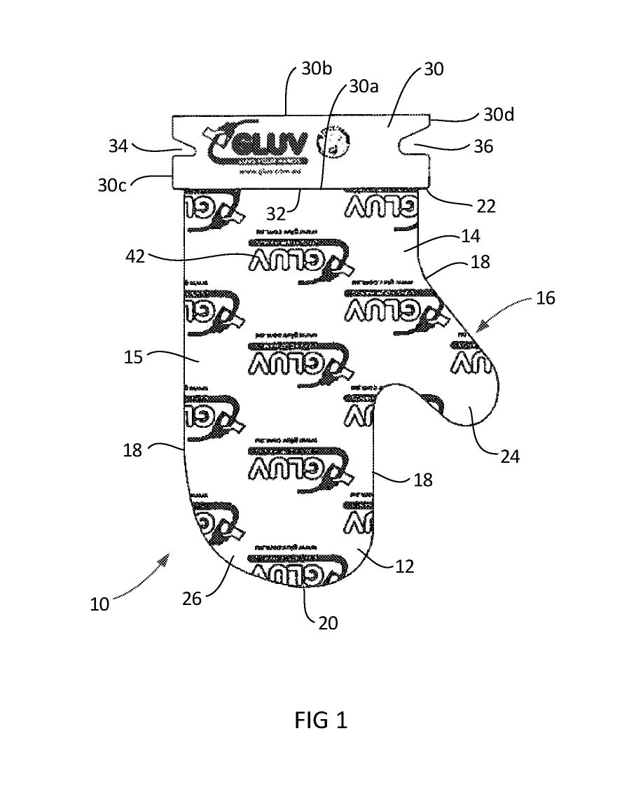

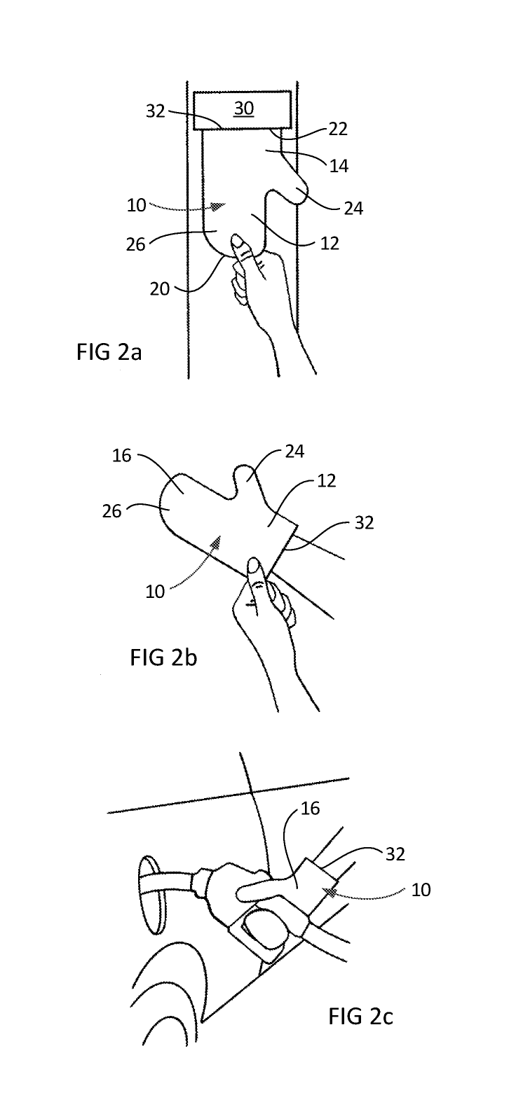

Referring to FIG. 1, there is shown a disposable mitten 10. The mitten 10 has a mitten body 12 formed from two layers of plastic. These layers are herein referred to as the first and second layers, 14, 16, respectively, and are manufactured from high-density polyethylene, including an OXO biodegradable additive, although other suitable materials are also contemplated. The specific OXO biodegradable additive utilised in the illustrated mitten 10 is REVERTED by Wells Plastic Limited. Only the first layer 14 is clearly visible in FIG. 1, because the second layer 16 underlies the first layer 14. The second layer is shown more clearly in FIGS. 2b and 2c. The layers 14, 16 have a thickness of 20 micron, although this may be varied, if desired.

The first layer 14 is sealed to the second layer 16 around the respective peripheries 18 of the two layers 14, 16, thereby providing a closed end 20 and an open end 22. It can be seen that the closed end 20 includes a thumb-receiving portion 24 and a fingers receiving portion 26 between the two layers 14, 16. Any practical sealing technique may be adopted for sealing the layers 14, 16 together, including heat sealing or radio frequency sealing.

Each of the first and second layers has an inner surface and an outer surface. The outer surface 15 of the first layer 14 is the only surface visible in FIG. 1.

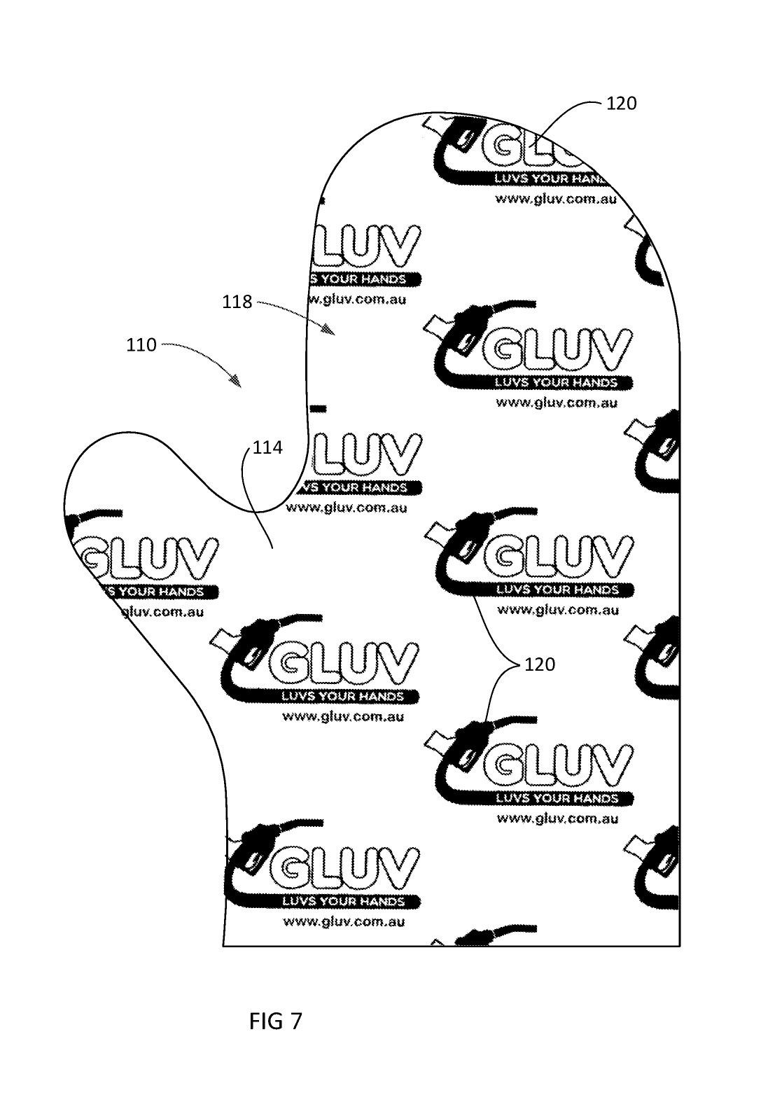

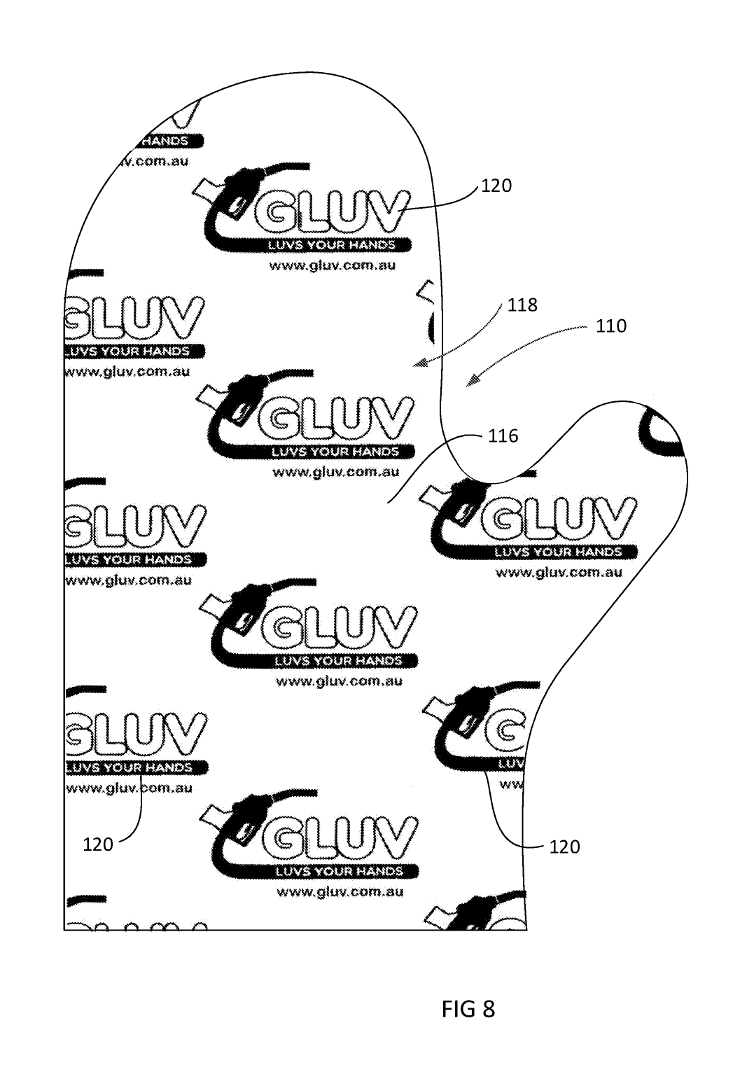

In the illustrated embodiment of FIGS. 1 and 2a to 2c an information display portion is provided over virtually the entire outer surface of both the first and second layers 14, 16, such that information provided in the information display portion is visible to the wearer while the mitten 10 is being worn, regardless of which hand the mitten 10 is being worn on. Neither the information display portion, nor the information thereon provided has been shown in the schematic illustrations of FIGS. 2a to 2c; although information (in the form of the applicant's logo) is clearly shown adorning the mitten 10 of FIG. 1. The mitten 110 shown in shown in FIGS. 7 and 8 clearly shows information 120 provided in an information display portion 118, which covers the entire outer surfaces of the first and second layers 114, 116 of the mitten 110 (although some other embodiments include an information display surface on only one of the first and second layers).

The information display portion 118 may be utilised to include important information on the mitten 10/110, such as safety steps to be followed when re-fuelling a car, such as “Turn off the vehicle engine” and “No smoking”. The information display portion may also be utilised for advertising purposes, since the rear side of the mitten provides a relatively broad area on which to display advertisements and the like. The mitten 110 is shown as displaying the applicant's logo, but could be replaced with advertising of the petrol station concerned, or advertising of some other entity or promotion.

The provision of a mitten 10 rather than, say, a glove provides the advantage that a larger uninterrupted area is provided for the information display portion. Further, a mitten 10/110 is generally easier to put on and take off than a glove, and can generally more easily be worn by individuals with a wider range of hand sizes, since the wearer's four fingers are collectively accommodated within the mitten, rather than individually accommodated in finger receiving portions of a glove.

Again, referring to FIGS. 7 and 8, the information 120 printed on the information display portion 118 is printed using one of the following inks obtained from Polykote Ink & Paint (Shenzhen) Ltd which, advantageously, is not adversely affected or compromised by contact with at least some vehicle fuels and oils typically sold at service stations during the relatively short-term expected life of the mitten 10/110, even if re-used several times. Other suitable inks, including those from other suppliers, may also be utilised.

| | FLEXOGRAPHIC & |
|---|---|
| FLEXOGRAPHIC & GRAVURE INK NO. | GRAVURE INK COLOR |
| Flexo/AA/Roto/TW/3M/F8101/2/3/4/5/6/8 | FLUORESCENT |
| | COLOR |
| HR/AA/TW/3M/103/62/A/M/-5/-8 | WHITE |
| HR/AA/TW/3M/074/075/077/91/95/97/M | BLACK/CONDUCTIVE |
| | BLACK |
| HR/AA/TW/3M/301/302/303/501/502/22/ | YELLOW |
| 32/33/A/M | |
| HR/AA/TW/3M/326/122E/794/795/796/26/ | YELLOW |
| 81/82/86/M | |
| HR/AA/TW/3M/020/797/20/50/87M | ORANGE |
| HR/AA/TW/3M/351/352/800/51/52/88/M | RED |
| HR/AA/TW/3M/430/432/798/799/13/17/M | RED |
| HR/AA/TW/3M/433/490/11/16/48/M | RED |
| HR/AA/TW/3M/126/79/M | GREEN |
| HR/AA/TW/3M/379/138/362/363/39/38/35/ | BLUE |
| 36/M | |
| HR/AA/TW/3M/356/358/56/58/M | MAGENTA |
| HR/AA/TW/3M/343/348/83/84/M | VIOLET |
| Flexo/AA/Roto/TW/3M/J180/181/89/92 | BRILLIANT PEARL |
| Flexo/AA/Roto/TW/3M/638/329/29/66/67/ | GOLD MEDIUM w/ |
| Silver | SILVER |
| Flexo/AA/Roto/TW/3M/638/66/67/Rich, | GOLD MEDIUM w/ |
| Pale Gold | GOLD |
| Flexo/AA/Roto/TW/3M/Luminous #1/#11 | YELLOW |
| F/R MATT PASTE | POLYKOTE/POLYVURE |
| | MATT PASTE |

Returning to FIGS. 1 and 2a to 2c, the mitten 10 has been specifically designed to provide a wearer protection from fuels, oils and like fluids, such as shown in FIGS. 2a to 2c when re-fuelling a vehicle at a petrol station. The mitten 10 is designed to be at least temporarily impervious to fuels/oils that a customer or employee is likely to encounter at a service station, thereby at least substantially preventing fuel/oil from splashing or spilling onto their hand(s). The mitten 10 also provides hygiene benefits, in that germs and bacteria potentially found on commonly handled items such as service station fuel pump handles, tyre inflators and the like won't be transferred to the hand of someone wearing the mitten 10.

The mitten 10 is designed to be disposable, although it is to be appreciated that it may be re-usable. It is intended that the mitten 10 will be sufficiently robustly manufactured to be re-used at least several times before finally being disposed. Thus, after an initial use, the mitten 10 may be stored in a vehicle glove box or compartment for later use when the vehicle next requires re-fuelling.

Again, the mitten 10 may also be used in other, non-service station applications, where it is desired to minimise any harmful effects resulting from handling a particular object; or where potential hygiene issues may be associated with handling an object.

A detachable portion 30 is attached to and extends from the respective end 32 of each of the first and second layers 14, 16 adjacent the open end 22 of the mitten 10 using staples (not shown) or other suitable arrangement. The detachable portion 30 is generally of two dimensional rectangular form, with oppositely disposed sides 30a, 30b extending between oppositely disposed first and second ends 30c, 30d. The detachable portion 30 is provided for releasably mounting the mitten within a dispenser 40 (such as shown in FIG. 5), which may be mounted on a wall or column adjacent a fuel pump or some other convenient location. The mitten 10 is designed such that the detachable portion 30 remains attached to the dispenser 40 upon removal of the mitten 10. A line of weakness 42 (in the form of a perforation line) is provided in the first and second layers 14, 16 along the side 30a of the detachable portion 30 where connected to both the first and second layers 14, 16 to facilitate manual removal of the mitten 10 from the detachable portion 30.

The detachable portion 30 is releasably mounted within the dispenser 40, for later removal.

It can be seen that the first end 30c of the detachable portion 30 includes a first attachment notch 34, and the second end 30d includes a second attachment notch 36. It is to be appreciated that the shape of notch 34 is different to that of notch 36, such that the overall shape of the detachable portion 30 is asymmetric. This asymmetric shape is desirable because it means that the detachable portion 30 is releasably mountable within the receiving portion 42 of the dispenser 40 in a single possible orientation relative to the dispenser 40, as shown in FIG. 5. Thus, when multiple mittens 10 are inserted into the dispenser 40 (either individually or, more preferably, as a cell of mittens) then they all have the same orientation as the mittens 10 shown in FIG. 5, with the thumb-receiving portion 24 shown on the right-hand side of the mittens 10. The detachable portion 30 may adopt any other suitable asymmetric shape, so long as it is compatible with (or keyed to) the shape of the receiving portion 44 discussed below. At least one embodiment of the invention includes a detachable portion and associated dispenser receiving portion that isn't asymmetric in shape.

Although not shown, a plurality of mittens 10 is preferably is provided in a stacked arrangement, with the detachable portion 30 of each mitten 10 connected together to provide a cell of connected mittens. This facilitates ease of handling of multiple mittens, and ease of adding multiple mittens to the dispenser 40. It also adds to the ease of later refilling the dispenser 40 when required. While each cell may include any desired number of individual mittens, the applicant is particularly contemplating cells containing approximately fifty mittens.

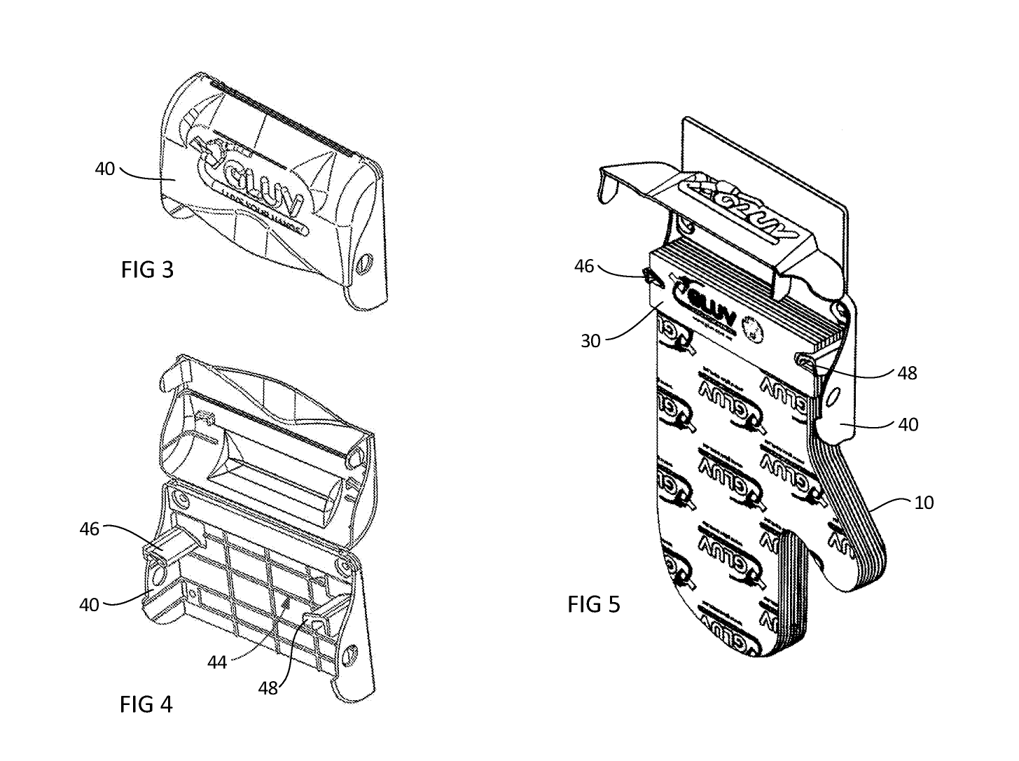

The dispenser 40 shown in FIGS. 3 to 5 is, as previously discussed, provided for containing and dispensing disposable mittens 10. It is specifically designed to be mounted on a vertical surface, such as the surface of a wall or column.

The dispenser 40 has a receiving portion 44. The receiving portion 44 includes a pair of protuberances 46, 48 provided for receiving the notches 34, 36. The protuberance 48 is larger than protuberance 46, and is capable of receiving notch 36, but is too big to receive notch 34. Thus, it is to be appreciated that the receiving portion 44 of the dispenser 40 is keyed to the shape of the detachable portion 30, for releasably receiving the detachable portion 30 of each mitten within the dispenser 40 in a single possible orientation. Thus, the shape of the receiving portion 44 can be considered asymmetric in shape. The receiving portion 44 may adopt any other suitable asymmetric shape, so long as it is compatible with the shape of the detachable portion 30.

Again, although the dispenser 40 is described immediately above in the context of use with a single mitten 10, it is to be appreciated that the dispenser 40 has been specifically designed for receiving and retaining a plurality of mittens 10 in one or more cells of stacked mittens. In this regard the receiving portion 44 and the protuberances 46, 48 are configured for receiving one or more cells of mittens. As such, the dispenser 40 is considered to be particularly suitable for mounting, for example, adjacent a service station fuel pump where customers are able to remove a single mitten 10 (or pair of mittens) prior to re-fuelling their vehicles.

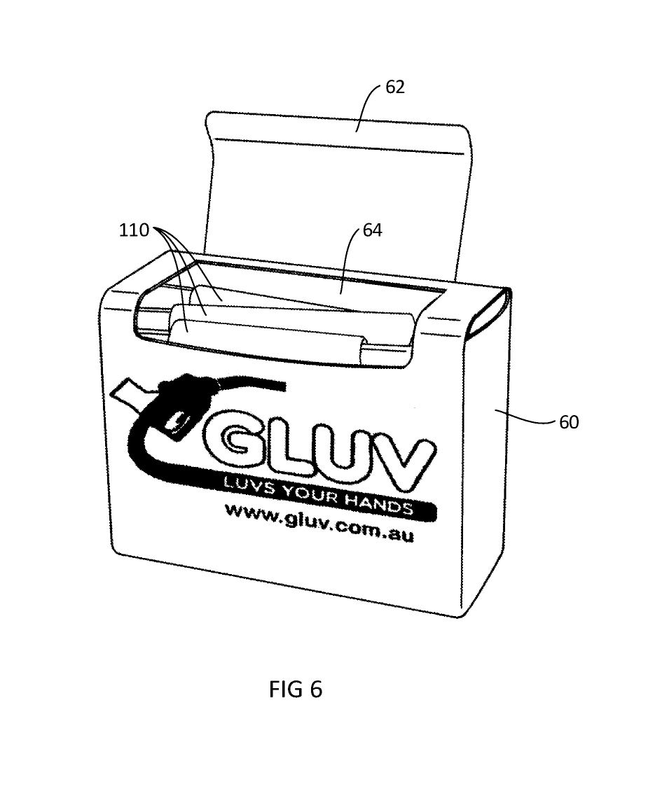

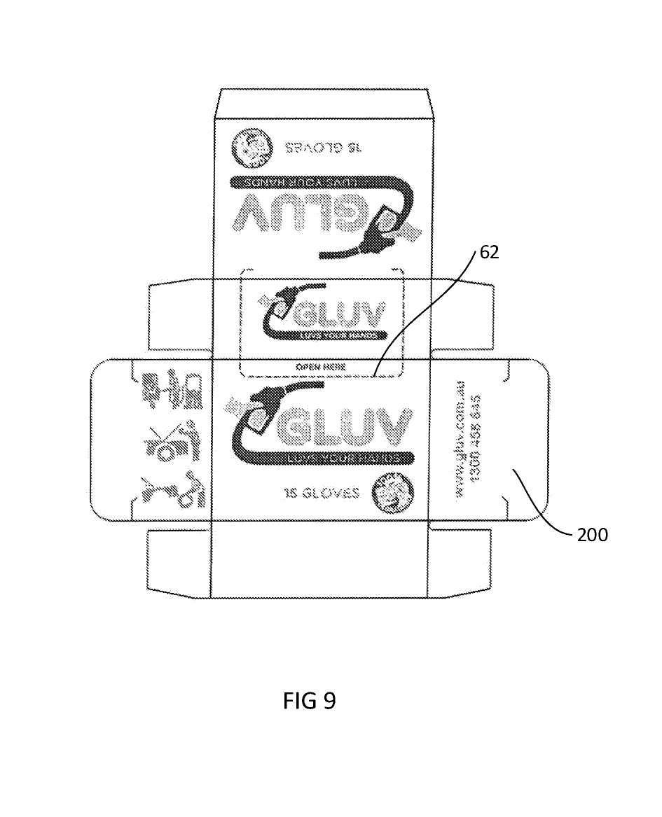

Referring to FIGS. 6 and 9, there is shown a portable container 60 (and blank 200 thereof) for containing and individually dispensing a plurality of disposable mittens 110 of the type shown in FIGS. 7 and 8. It is to be noted that the mittens 110 differ from that shown in FIG. 1, in that they don't include a detachable portion 30. Each of the mittens 110 is individually folded and packaged in the portable container 60. The portable container 60 has been specifically (although not exclusively) designed to store a relatively small number of mittens 110 for personal use. The container 60 is provided in a size and shape for conveniently storing in the cabin of a motor vehicle, in a clothing pocket or in a bag or handbag. The container 60 shown is manufactured from the cardboard blank 200 and holds fifteen mittens 110, although the size and/or shape of the container 60 may be varied to hold a greater or lesser number of mittens if desired.

The container 60 is provided with a tear-open flap 62, enabling individual mittens 110 to be removed from the container 60 through the opening 64 as required. The tear-open flap 62 may be closed by inserting the flap 62 back through the opening 64.

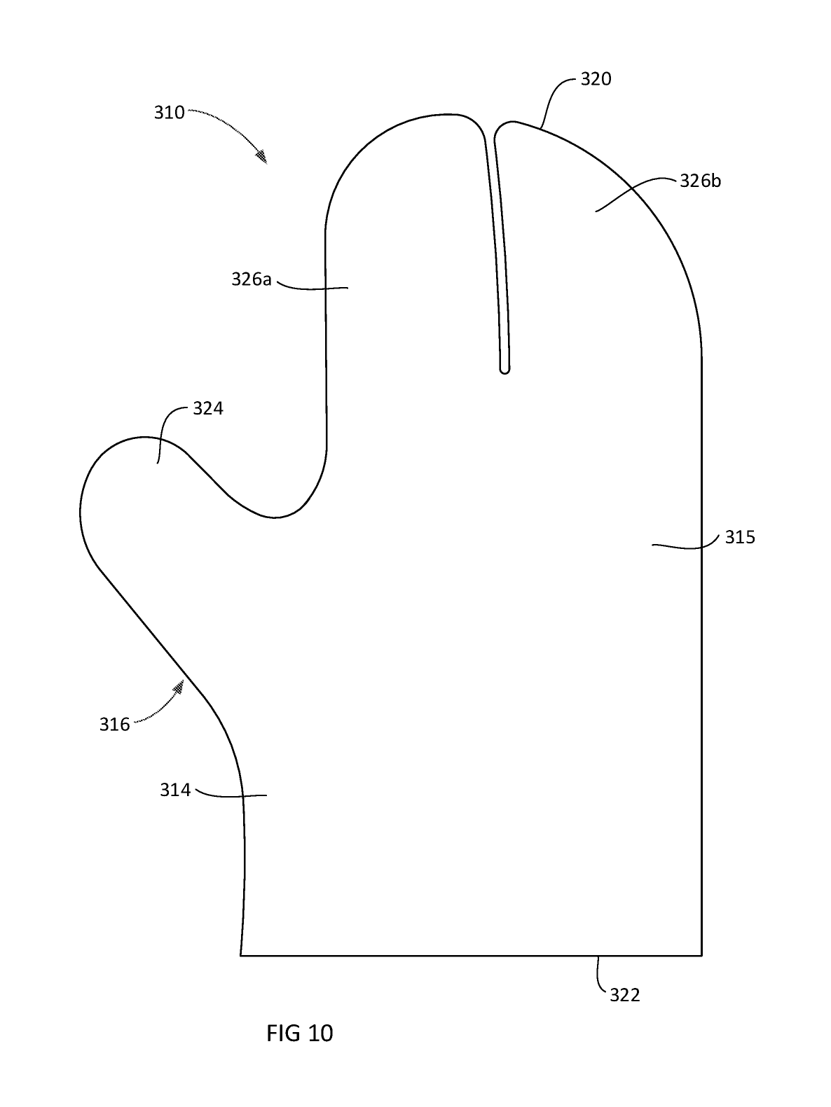

An alternate disposable mitten 310 embodiment is shown in FIG. 10. The mitten 310 includes a first layer 314 that is sealed to a second layer 316 around the respective peripheries 318 of the two layers 314, 316, thereby providing a closed end 320 and an open end 322. It can be seen that the closed end 320 includes a thumb-receiving portion 324 and two fingers receiving portions 326a, b between the two layers 314, 316. The portion 326a is provided for receiving the index and middle fingers, while the portion 326b is provided for receiving the ring and small fingers.

Each of the first and second layers 314, 316 has an inner surface and an outer surface. The outer surface 315 of the first layer 314 is the only surface visible in FIG. 10.

In the illustrated embodiment of FIG. 10, an information display portion is provided over virtually the entire outer surface of both the first and second layers 314, 316, such that information provided in the information display portion is visible to the wearer while the mitten 310 is being worn, regardless of which hand the mitten 310 is being worn on. That said, neither the information display portion, nor the information thereon provided has been shown in the schematic illustration of FIG. 10.

The disposable mitten 10/110/310 of the present invention can be used in a wide variety of applications, and is especially useful in the context of refuelling a vehicle at a service station. This is because they provide a barrier to protect the wearer's hand(s) from contact with fuel, oil and other fluids. It also provides a more hygienic way of handling service station items such as petrol pumps, and the like. The mitten 10/110/310 provides a cost effective way of protecting a wearer's hand, as well as providing a useful medium for carrying advertising, instructional, warning and/or other information.

The mitten 10/110/310 can advantageously accommodate a wider range of wearer hand sizes than generally possible with disposable gloves, such that a single size of mitten can potentially be worn by individuals with a relatively wide range of hand sizes.

Also, the mitten 10/110/310 is generally better able to carry information visible by a wearer, since the back side of the mitten 10/110/310 is a wider, more continuous surface on which to provide the information when compared to that provided on the back side of a glove.

Desirably, the material from which the mitten 10/110/310 is manufactured is not affected (at least in the short term) by fuels and oils typically found at service stations.

Moreover, the ink used to print on the mitten 10/110/310 has desirably been found not to be affected (at least in the short term) from contact with at least some fuels and oils typically found at service stations. Thus, the invention provides the advantage that any information adorning the mitten 10/110/310 is not compromised (at least in the short term) by inadvertent contact with at least some service station fuels or oils.

Finally, it is to be understood that various alterations, modifications and/or additions may be introduced into the construction and arrangement of the parts previously described without departing from the spirit or ambit of this invention.

1. A disposable mitten having a mitten body formed from first and second layers, each layer having an inner surface and an outer surface, and an information display portion provided on at least one of the first and second layers, such that information provided in the information display portion is visible to the wearer while the mitten is being worn, the mitten comprising a detachable portion attached to and extending from at least one of the first and second layers adjacent an open end of the mitten, wherein the detachable portion is asymmetric in shape, such that the detachable portion is releasably mountable within a receiving portion of a dispenser in a single orientation relative to the dispenser.

2. The disposable mitten according to claim 1, wherein the information display portion is printed on the outer surface of at least one of the first and second layers.

3. The disposable mitten according to claim 2, wherein the information display portion is printed on the outer surface of both the first and second layers.

4. The disposable mitten according to claim 2, wherein the information display portion is printed on the outer surface of one of the first and second layers.

5. The disposable mitten according to claim 1, wherein the first layer of the mitten body is sealed to the second layer of the mitten body around the respective periphery thereof forming a closed end and an open end, and further forming a thumb-receiving portion and a fingers receiving portion.

6. The disposable mitten according to claim 1, wherein the first and second layers are at least substantially manufactured from one of corn starch, plastic and a polymer.

7. The disposable mitten according to claim 6, wherein the first and second layers are manufactured from high-density polyethylene (HDPE).

8. The disposable mitten according to claim 6, wherein the first and second layers are manufactured from high-density polyethylene and further include an OXO additive.

9. The disposable mitten according to claim 1, the detachable portion or disposable mitten comprising a line of weakness suitable for separation of the detachable portion from the mitten body, or a line of weakness provided between the detachable portion and disposable mitten suitable for separation of the detachable portion from the mitten body.

10. The disposable mitten according to claim 9, wherein the detachable portion is releasably mountable within the dispenser.

11. The disposable mitten according to claim 10, wherein a receiving portion of the dispenser is keyed to the shape of the detachable portion.

12. The disposable mitten according to claim 9, the detachable portion comprising oppositely disposed first and second sides, with the line of weakness provided along the first side, with each side extending between oppositely disposed first and second ends, with the first end comprising a first attachment notch and the second end comprising a second attachment notch, with the first notch being at least one of a different shape, size and relative position along the first side compared to the shape, size and relative position along the second side of the second notch.

13. The disposable mitten according to claim 1, comprising a thumb receiving portion and a finger receiving portion.

14. The disposable mitten according to claim 13, comprising a second finger receiving portion.

15. The disposable mitten according to claim 14, comprising a third finger receiving portion.

16. The plurality of mittens, with each mitten of the plurality of mittens according to claim 9, and wherein the plurality of mittens are provided in a stacked arrangement, with the detachable portion of each mitten connected together to provide a cell of connected mittens.

17. The plurality of mittens according to claim 16, wherein the cell of mittens contains approximately 50 mittens.

18. A dispenser for containing and dispensing a disposable mitten, wherein the dispenser has a receiving portion having an asymmetric shape for receiving a detachable portion of the disposable mitten, the detachable portion also comprising an asymmetric shape, and further wherein the receiving portion of the dispenser is keyed to the shape of the detachable portion, such that the detachable portion is releasably mountable within the receiving portion in a single orientation relative to the dispenser.

19. The dispenser according to claim 18, when configured for receiving a cell of stacked mittens.

20. The dispenser according to claim 19, wherein the dispenser is configured for concurrently receiving a plurality of cells of stacked mittens.

21. A portable container for containing and individually dispensing a plurality of disposable mittens, wherein, in use, each of the plurality of mittens is individually folded and packaged in the portable container.

22. The portable container according to claim 21, wherein the portable container is manufactured from cardboard, and contains approximately fifteen folded mittens, the portable container further comprising a tear-open flap for individually removing the folded mittens therefrom.

23. The portable container according to claim 22, wherein the tear-open flap of the portable container is re-closable.

24. The portable container according to claim 21, wherein the portable container is manufactured from plastic film.

25. The portable container according to claim 24, wherein the container contains approximately four mittens.

26. A portable container for containing and dispensing a plurality of disposable mittens, wherein, in use, the plurality of mittens are interleaved or group folded within the portable container.

27. The portable container according to claim 26, wherein the portable container is manufactured from plastic film.

28. The portable container according to claim 26, wherein the container contains approximately four mittens.
